(19) United States
(12) Patent Application Publication
(10) Pub. No.: US 2025/0265841 A1
(43) Pub. Date: Aug. 21, 2025

(54) SYSTEM FOR CAPTURING VIDEO IMAGES OF LIVE SPORTING EVENTS AND METHODS OF OPERATING SAME

(71) Applicant: Skill Shot, LLC, Farmington, IL (US)

(72) Inventors: Kevin Reed, Farmington, IL (US); Marshall Threw, Farmington, IL (US); Christopher Caldwell, Normal, IL (US)

(21) Appl. No.: 19/054,064

(22) Filed: Feb. 14, 2025

Related U.S. Application Data
(60) Provisional application No. 63/554,023, filed on Feb. 15, 2024.

(51) Int. Cl. G06V 20/40; G06F 3/04842; G06F 3/0488; G06V 20/64; H04N 23/63

(52) U.S. Cl. CPC G06V 20/42; G06F 3/04842; G06F 3/0488; G06V 20/64; H04N 23/631

(57) ABSTRACT

A computer system for use in capturing video images of sport skill event is described herein. The computer system includes a mobile computing device including a touchscreen, a video camera for capturing video images, and one or more processors programmed to execute an algorithm including the steps of recording video images shown in a video capture window, rendering a golf skill shot confirmation window overlaying a portion of the video capture window, analyzing video capture data to detect video images of a golf ball and completion of the golf skill shot by the player, and displaying a celebration notification screen on the touchscreen upon determining the recorded video images includes successful completion of the golf skill shot.

### CROSS REFERENCE TO RELATED APPLICATIONS

This application claims the benefit of U.S. Provisional application Ser. No. 63/554,023, filed on Feb. 15, 2024, the disclosures of which are hereby incorporated by reference in their entirety and for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The present invention relates to computer systems for capturing video images of live sporting events for use in placing wagers on live sporting events or contests of skill and methods of operating the system using mobile computing devices.

### BACKGROUND OF THE INVENTION

At least some known online betting systems allow users to place wagers on various sporting events based on odds associated with the sporting event outcomes. In addition, know online betting systems include geo-fencing capabilities to determine the location of the mobile devices used when accessing the online betting mobile applications. However, these known systems are not capable of allowing players to place wagers based on their own participation in the sporting events because of difficulties in verifying real-time outcomes of these sporting events.

The present invention solves one or more of the problems identified above.

### SUMMARY OF INVENTION

In one aspect of the present invention, a computer system for use in capturing video images of sport skill event is provided. The computer system includes a mobile computing device including a touchscreen display device including a graphical user interface (GUI) display screen displaying computer-generated images thereon, a video camera for capturing video images, a memory device including computer-executable instructions for performing an algorithm to capture video images of a player completing a golf skill shot and one or more processors programmed to execute the computer-executable instructions to perform the algorithm. When executing the computer-executable instructions, the one or more processors perform the algorithm including the steps of receiving a request to record video images of the golf skill shot via the touchscreen GUI display screen and initiating a golf skill shot capture event by displaying a video capture screen on the touchscreen GUI display screen including a video capture window displaying images received from the video camera and a video record button. The processor then receives a first user selection via the touchscreen GUI display screen of the video record button to initiate a video recording session and initiating the video recording session by recording video images shown in the video capture window being capture by the video camera including the player performing the golf skill shot and rendering a golf skill shot confirmation window on the video capture screen overlaying a portion of the video capture window including a confirmation button. The processor then receives a second user selection via touchscreen GUI display screen of the confirmation button and removes the golf skill shot confirmation window from the video capture screen. The processor receives a third user selection via touchscreen GUI display screen of the video record button and terminating the video recording session by stopping the recording of video images shown in the video capture window, and generating a golf skill shot datafile including video capture data including the recorded video images shown in the video capture window. The processor then analyzes the video capture data to detect video images of a golf ball and completion of the golf skill shot by the player and displays a celebration notification screen on the touchscreen GUI display screen upon determining the recorded video images show successful completion of the golf skill shot.

In another aspect of the present invention, a method of operating a computer system for use in capturing video images of sport skill event is provided. The computer system includes a mobile computing device including a touchscreen display device including a graphical user interface (GUI) display screen displaying computer-generated images thereon, a video camera for capturing video images, a memory device including computer-executable instructions for performing an algorithm to capture video images of a player completing a golf skill shot, and one or more processors programmed to execute the computer-executable instructions to perform the algorithm. The method includes the one or more processors performing the algorithm including the steps of receiving a request to record video images of the golf skill shot via the touchscreen GUI display screen and initiating a golf skill shot capture event by displaying a video capture screen on the touchscreen GUI display screen including a video capture window displaying images received from the video camera and a video record button. The processor then receives a first user selection via the touchscreen GUI display screen of the video record button to initiate a video recording session and initiating the video recording session by recording video images shown in the video capture window being capture by the video camera including the player performing the golf skill shot and rendering a golf skill shot confirmation window on the video capture screen overlaying a portion of the video capture window including a confirmation button. The processor then receives a second user selection via touchscreen GUI display screen of the confirmation button and removes the golf skill shot confirmation window from the video capture screen. The processor receives a third user selection via touchscreen GUI display screen of the video record button and terminating the video recording session by stopping the recording of video images shown in the video capture window, and generating a golf skill shot datafile including video capture data including the recorded video images shown in the video capture window. The processor then analyzes the video capture data to detect video images of a golf ball and completion of the golf skill shot by the player and displays a celebration notification screen on the touchscreen GUI display screen upon determining the recorded video images show successful completion of the golf skill shot.

In yet another aspect of the present invention, a non-transitory computer-readable storage media having computer-executable instructions embodied thereon for operating a computer system is provided. The computer system includes a mobile computing device including a touchscreen display device including a graphical user interface (GUI) display screen displaying computer- generated images thereon, a video camera for capturing video images, and one or more processors. When executed by the one or more processors the computer-executable instructions cause the one or more processors to perform an algorithm to capture video images of a player completing a golf skill shot including the steps of receiving a request to record video images of the golf skill shot via the touchscreen GUI display screen and initiating a golf skill shot capture event by displaying a video capture screen on the touchscreen GUI display screen including a video capture window displaying images received from the video camera and a video record button. The processor then receives a first user selection via the touchscreen GUI display screen of the video record button to initiate a video recording session and initiating the video recording session by recording video images shown in the video capture window being capture by the video camera including the player performing the golf skill shot and rendering a golf skill shot confirmation window on the video capture screen overlaying a portion of the video capture window including a confirmation button. The processor then receives a second user selection via touchscreen GUI display screen of the confirmation button and removes the golf skill shot confirmation window from the video capture screen. The processor receives a third user selection via touchscreen GUI display screen of the video record button and terminating the video recording session by stopping the recording of video images shown in the video capture window, and generating a golf skill shot datafile including video capture data including the recorded video images shown in the video capture window. The processor then analyzes the video capture data to detect video images of a golf ball and completion of the golf skill shot by the player and displays a celebration notification screen on the touchscreen GUI display screen upon determining the recorded video images show successful completion of the golf skill shot.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system for use in placing wagers on a live sporting event via mobile computing devices, according to an embodiment of the present invention;

FIGS. 2-4 are flow charts illustrating algorithms used during operation of the system shown in FIG. 1, according to an embodiment of the present invention;

FIGS. 5-8 are illustration of a datafiles that may be used to by the system when executing the algorithms shown in FIGS. 2-4, according to an embodiment of the present invention.

FIGS. 9-30 are exemplary screenshots of display screens that may be displayed on mobile computing devices to allow users to operate the system shown in FIG. 1 and illustrating the algorithms shown in FIGS. 2-4.

Corresponding reference characters indicate corresponding parts throughout the drawings.

### DETAILED DESCRIPTION OF THE PREFERRED EMBODIMENT

A selected embodiment of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

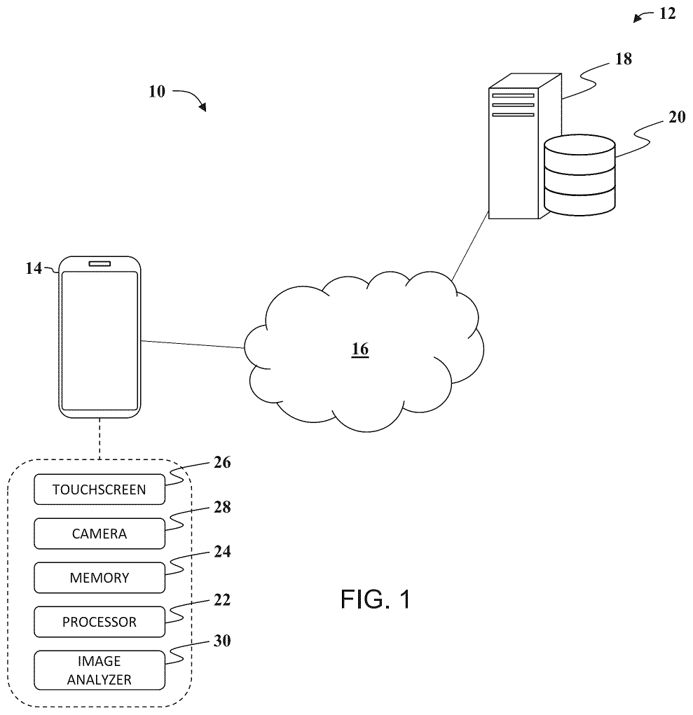

FIG. 1 is a schematic representation of the Skill Shot™ system 10 that may be used to allow players to post video images of golf shots and receive awards from accomplishing performance goals associated with the golf shots. The Skill Shot™ system 10 provide the user with the unique ability to place a wager on oneself on live sporting events or contests of skill, and is not just another app to place wagers on other players participating in live sporting events. For example, in some embodiments, the system 10 provides an award to a player for completing golf skill events such as a Hole-in-One (HOI) golf skill competition, hitting it within the distance of the flagstick (from the hole) and landing it on the green, making a 20+ foot putt, chipping it in, driving it 250+ yards in the fairway, bowling skill events, billiards skill events, darts, frisbee golf skill events, and the like.

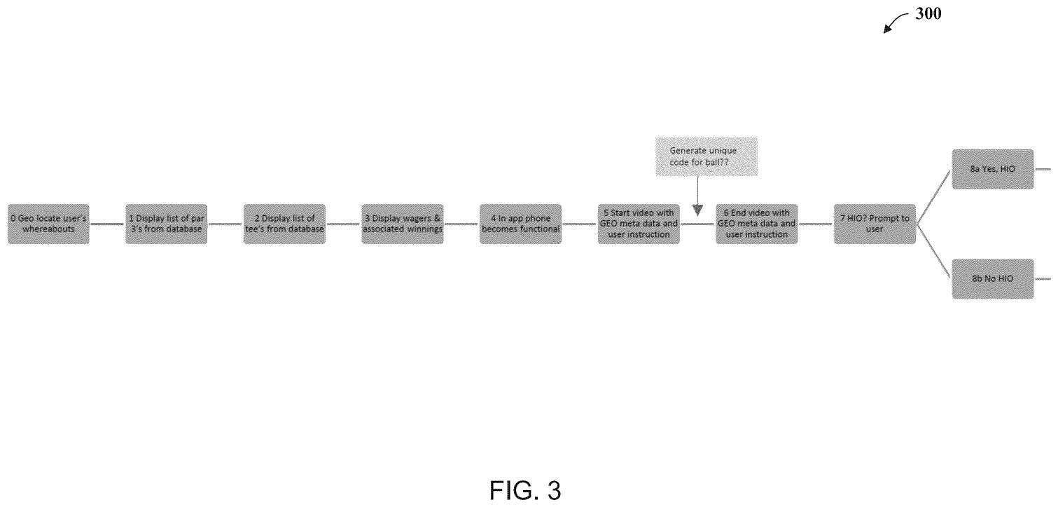

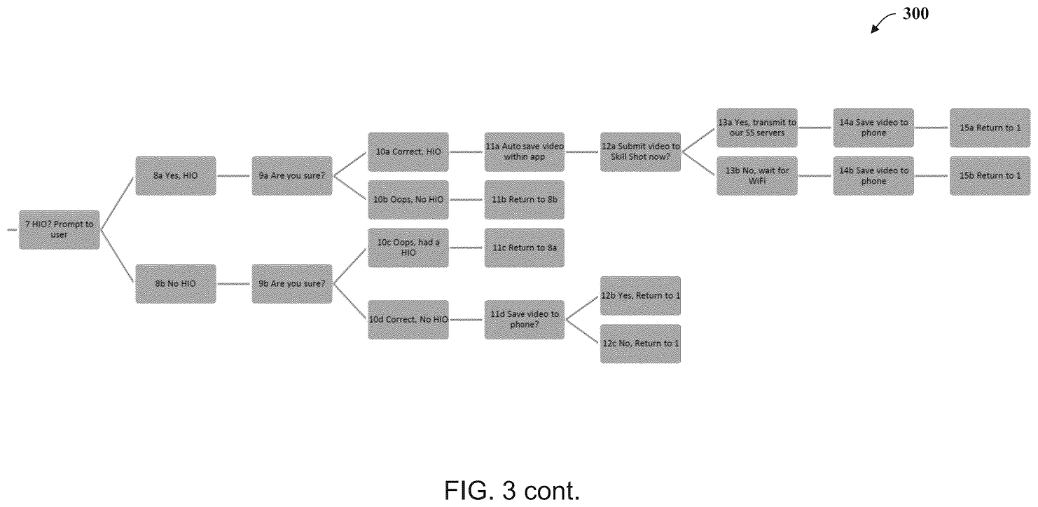

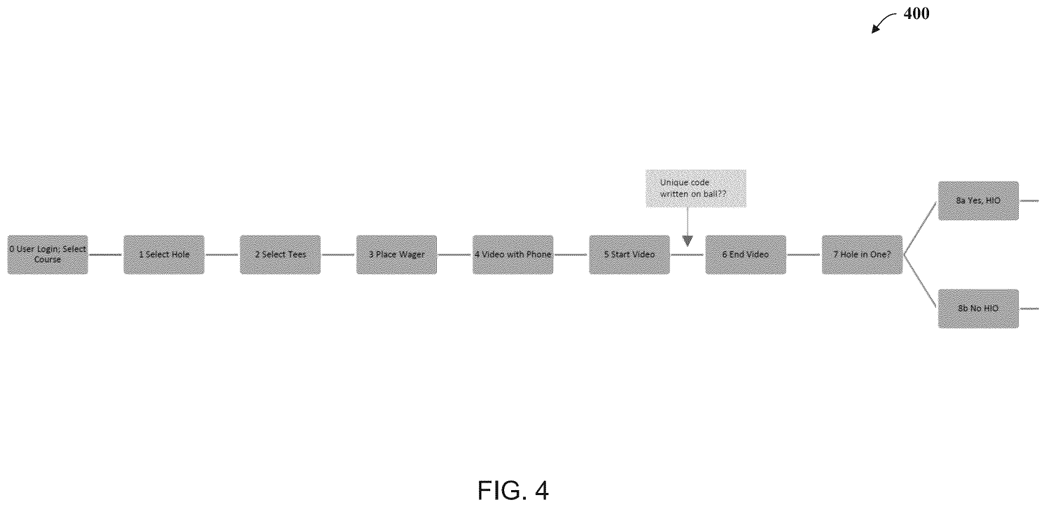

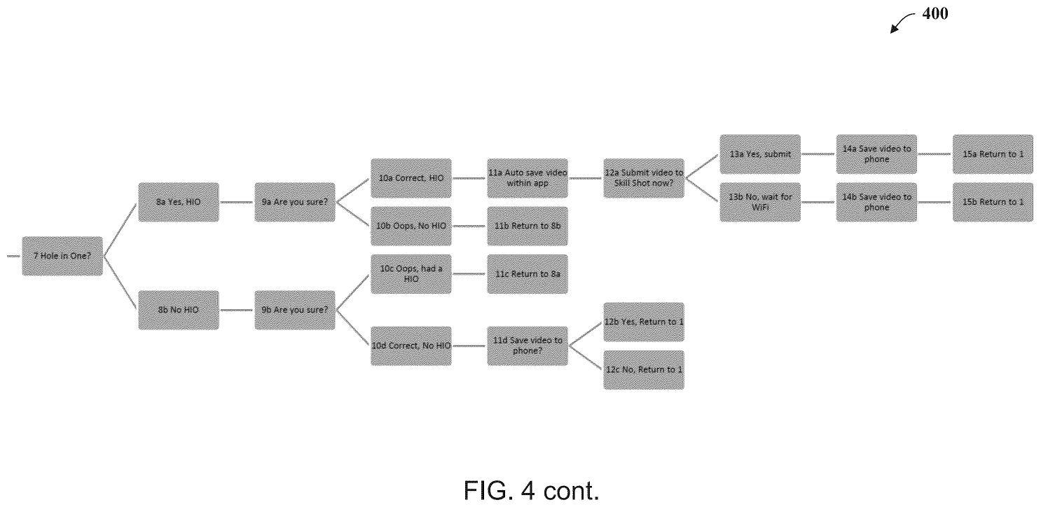

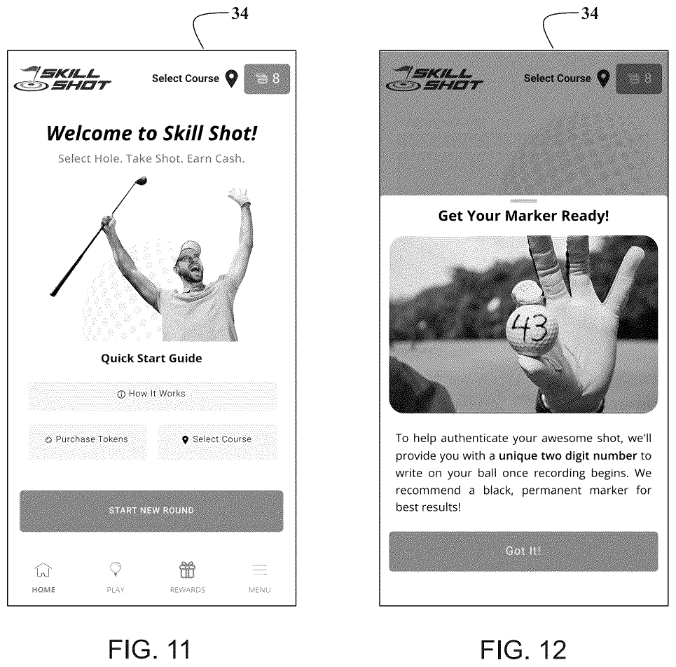

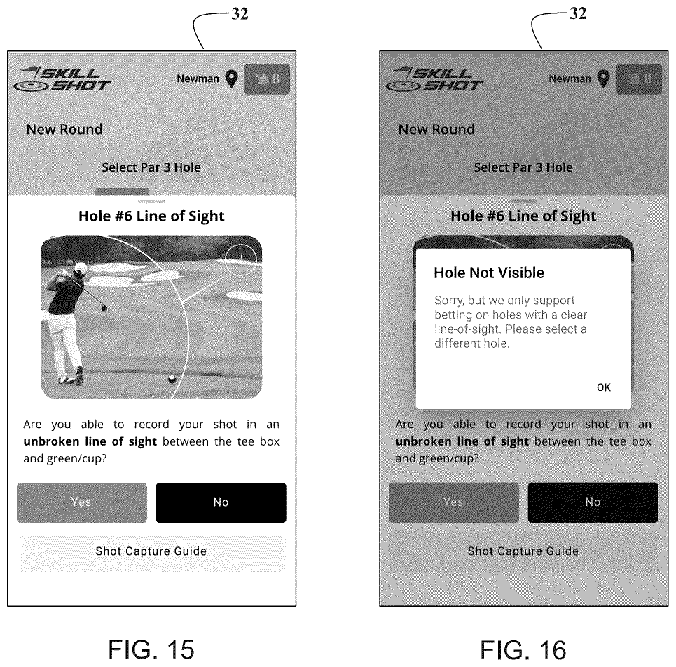

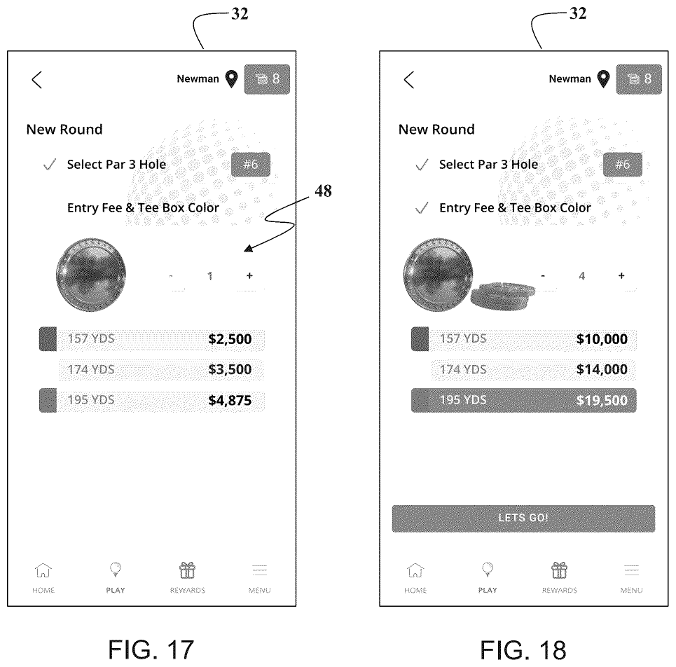

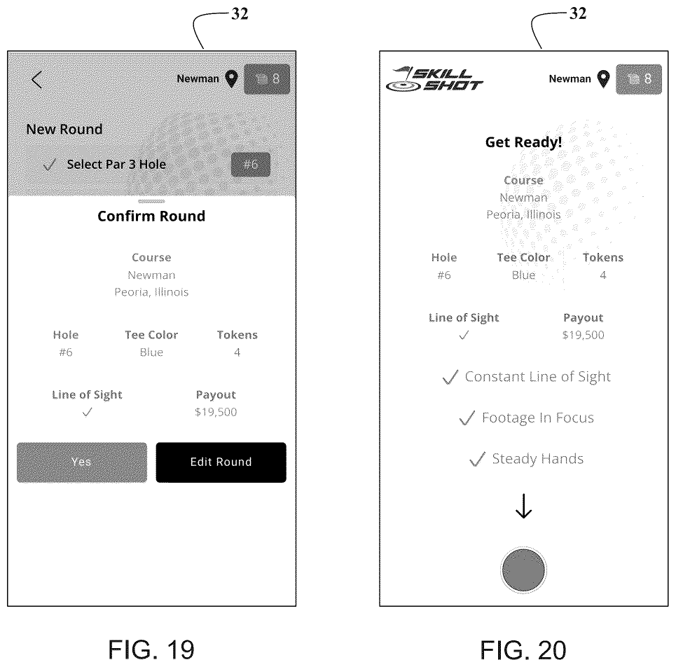

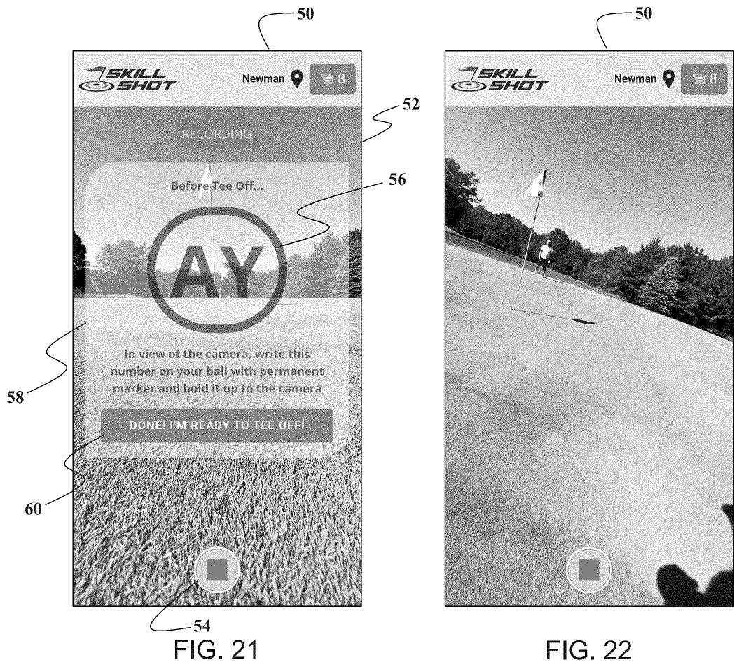

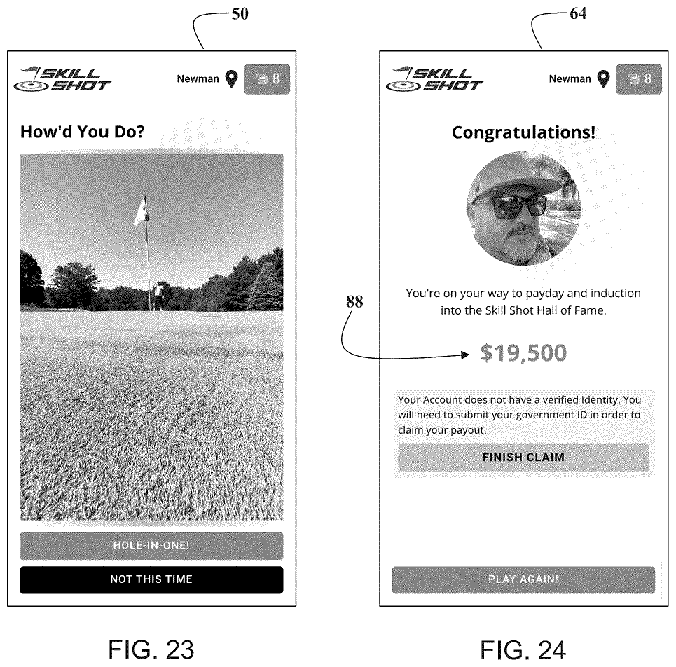

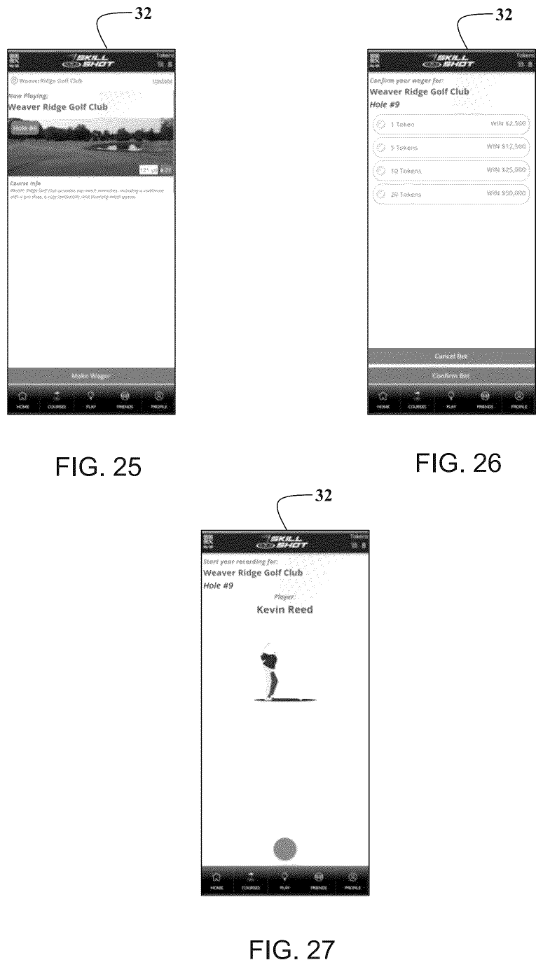

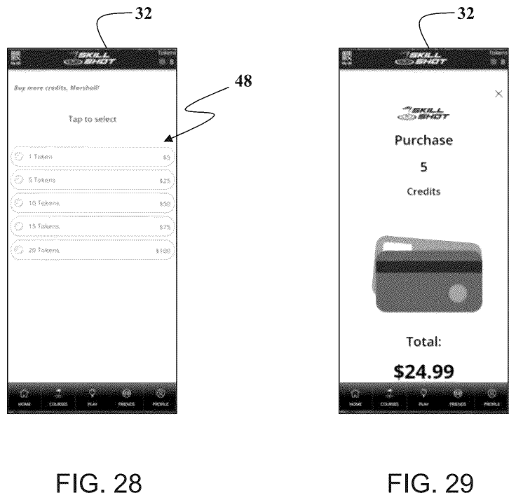

Referring to FIGS. 1-30, in the illustrated embodiment, the system 10 includes a system server 12 and one or more mobile computing devices 14 that are coupled in communication via a communications network 16. The communications network 16 may be any suitable connection, including the Internet, file transfer protocol (FTP), an Intranet, a local area network (LAN), a wide area network (WAN), dial-in-connections, a virtual private network (VPN), cellular networks, and/or any suitable communications network, and may utilize any suitable or combination of technologies including, but not limited to wired and wireless connections, always on connections, connections made periodically, and connections made as needed.

Each mobile computing device 14 includes any suitable device that enables a user to access and communicate with the system 10 including sending and/or receiving information to and from the system 10, and displaying information received from the system 10 to a user. The mobile computing device 14 may include, but is not limited to, smartphone, a tablet computer, smartphone/tablet computer hybrid, a desktop computer, a laptop or notebook computer, a personal data assistant, a handheld mobile device including a cellular telephone, and the like. For example, the mobile computing device 14 may include a smartphone such as an iPhone™, Samsung Galaxy™, Google Pixel™ and the like. The mobile computing device 14 includes one or more processors 22 coupled to a memory device 24 for storing various programs and data for use in operating the mobile computing device. For example, the memory device 24 includes computer-executable instructions for performing an algorithm to capture video images of a player completing a golf skill shot, and the one or more processors 22 are programmed to execute the computer-executable instructions to perform the algorithm. The mobile computing device 14 also includes a touchscreen display device 26 including a graphical user interface (GUI) display screen displaying computer-generated images thereon, one or more video image cameras 28 for capturing video images, one or more speakers, a microphone, at least one input button, and one or more sensors including, but not limited to, a barometer, a three-axis gyro, an accelerometer, proximity sensor, and an ambient light sensor. In addition, the mobile computing device may also include a Wi-Fi antenna, a cellular network antenna, a Bluetooth™ communications device, a global positioning system (GPS) device such as assisted GPS and GLONASS, a digital compass, and an iBeacon™ microlocation device.

The mobile computing device 14 may be programmed to store and execute mobile computer program applications that display graphical user interfaces on the touchscreen display unit that allows the user to access the system 10 to retrieve and store information within the system 10 as well as interact with and operate the system 10. In some embodiments, the mobile computing device 14 may include AI image analyzer software 30 that uses artificial intelligence to analyze digital images, extracting information by identifying objects, patterns, and features within the image, allowing for automated classification, tagging, and interpretation of visual data, such as, for example, Apple Intelligence™, OpenAI™ DALL-E™, Azure™ AI Vision Image Analysis™ by Microsoft™, or similar AI image analyzers used for analyzing video images recorded by the video image camera.

The system server 12 includes a system controller that includes a central processing unit (CPU) 18 and a database 20. The CPU 18 includes a processor and a memory device and executes various programs, and thereby controls components of the system server 12 according to user instructions received from the mobile computing device 14. The memory device stores various programs and information in the database 20, and retrieves information from the database 20 that is used by the processor to perform various functions described herein. The CPU 18 is programmed to host a website that is accessible by a user via one or more mobile computing devices 14. The CPU 18 retrieves and stores web pages from the database 20 and displays the webpages on the mobile computing devices 14 to allow users to interact with the system 10 to access user account, request betting information, golf course information, and place and monitor wagers. In one embodiment, the mobile computing device 14 may include a mobile application that allows the CPU 18 to communicate with the mobile computing device 14 to allow the user to operate the system 10 via the mobile computing device 14. In some embodiments, the system server 12 may also include the AI image analyzer software 30 that uses artificial intelligence to analyze digital images, extracting information by identifying objects, patterns, and features within the image, allowing for automated classification, tagging, and interpretation of visual data, such as, for example, Apple Intelligence™, OpenAI™ DALL-E™, Azure™ AI Vision Image Analysis™ by Microsoft™, or similar AI image analyzers used for analyzing video images.

The database 20 contains information on a variety of matters, such as, for example, user profile accounts, wagering information, golf course information including GPS coordinates associated with a plurality of hole locations, course yardage, hole yardage, etc., unique golf ball identifies, web pages, search queries, data records, and/or any suitable information that enables the system 10 to function as described herein.

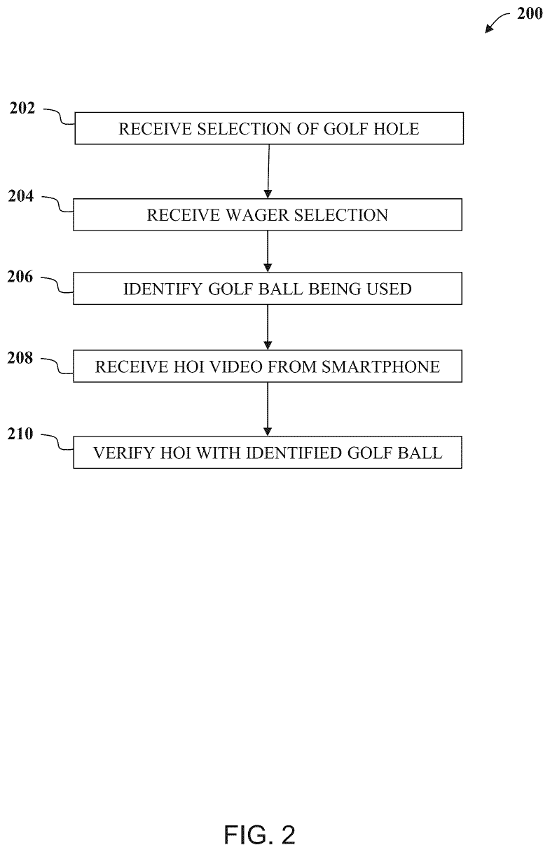

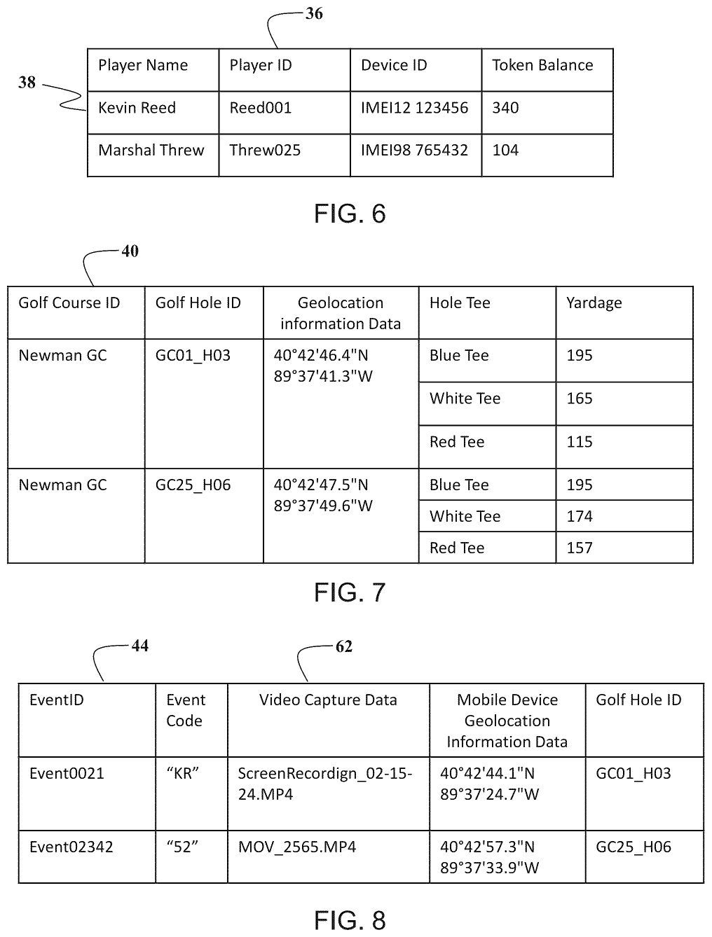

FIGS. 2-4 are flow charts of methods 200, 300, and 400 illustrating the algorithms performed by the processor 18, 22 when executing mobile application programs via the mobile computing device 14 to allow a player to post video images of golf shots and receive awards from accomplishing performance goals associated with the golf shots. The methods include a plurality of steps. Each method step may be performed independently of, or in combination with, other method steps. Portions of the methods may be performed by any one of, or any combination of, the components of the system server 12 and/or the mobile computing devices 14. FIGS. 6-31 are exemplary screenshots of display screens that may be displayed on mobile computing devices illustrating methods 200, 300, and 400.

In the illustrated embodiment, the mobile computing device 14 includes may include a mobile application including computer-executable instructions for performing algorithm to capture video images of a player completing a golf skill shot. The one or more processors 22 of the mobile computing device 14 are programmed to execute the computer-executable instructions to perform the algorithm to initiating a golf skill shot capture event by randomly selected two-digit code and displaying the two-digit code on the mobile computing device 14, recording video images being capture by the video camera 28 of the mobile computing device 14 including the player performing the golf skill shot, and analyzing the video capture data to detect video images of a golf ball and completion of the golf skill shot by the player. The processors 22 then render a celebration notification screen on the mobile computing device 14 upon determining the recorded video images of the golf ball displays a hand-written two-digit code matching the randomly selected two-digit code displayed on the golf skill shot confirmation window and the recorded video images show successful completion of the golf skill shot.

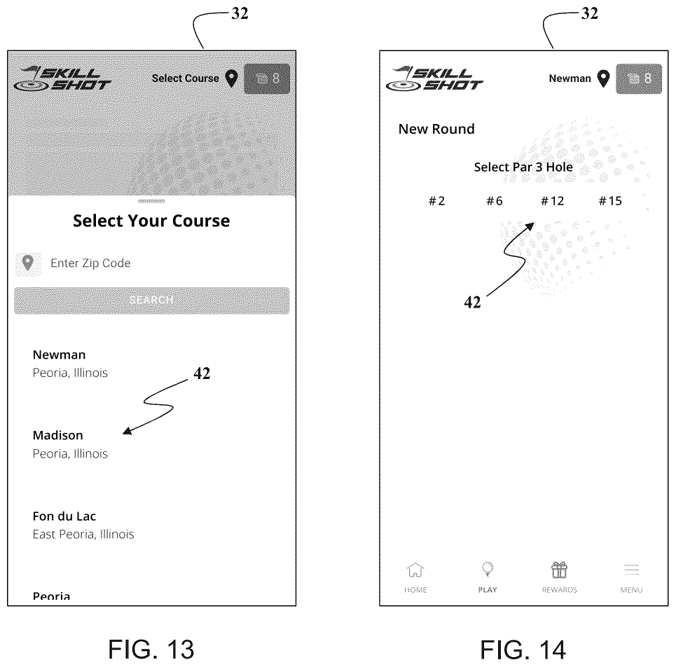

For example, in method step 202, the processor 18, 22 receives a request from a player via a mobile computing device 14 to select a golf hole for a golf skill shot competition event from a mobile computing device including GPS data from the mobile computing device 14 indicating the geographic location of the mobile computing device 14. The processor 18, 22 then determines a golf course and hole locations associate with the received GPS data, displays a golf hole selection screen 32 (shown in FIGS. 13-20) on the mobile computing device 14 including the determined golf course and hole locations, and receives a hole selection from the player via the mobile computing device 14.

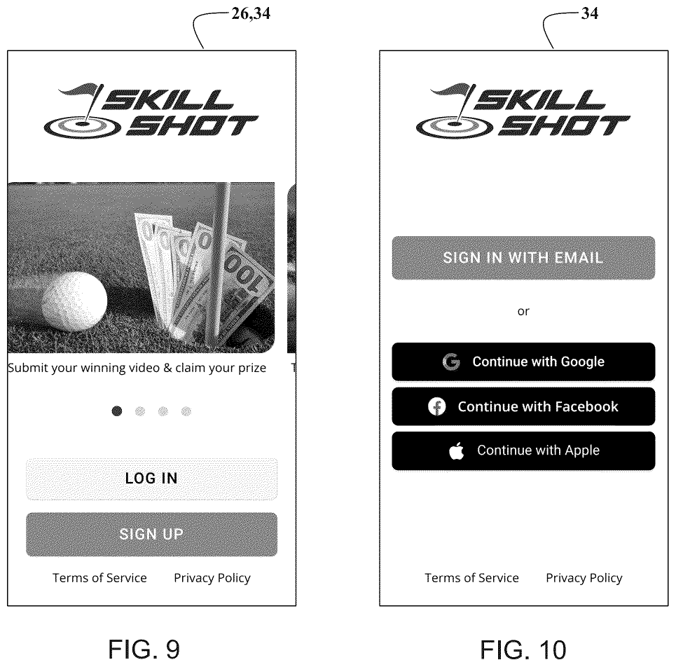

For example, in some embodiments, the processor 18, 22 may initiate the golf skill shot capture event by displaying a log-in screen 34 (shown in FIGS. 9-12) on the touchscreen GUI display screen 26 prompting the player to provide log-in credentials including a player ID. Upon receiving the player log-in credentials, the processor 18, 22 identifies a mobile device ID associated with the mobile computing device 14 and initiates a golf skill shot capture event by accessing a user account data file 36 (shown in FIG. 6) including information associated with a plurality of user accounts 38 including a player name, player ID, Device ID, and a token balance, and identifying a corresponding user account 38 matching the received player ID included in the log-in credentials and the mobile device ID associated with the mobile computing device.

The processor 18, 22 then receives geolocation information from the mobile computing device 14 via the GPS device identifying a position of the mobile computing device 14, accesses a golf course datafile 40 (shown in FIG. 7) including geolocation information associated with eligible golf hole locations, and initiates the golf skill shot capture event by accessing the golf course datafile 40, identifying eligible golf hole locations based on the received geolocation information of the mobile computing device 14, and rendering a golf hole selection screen 32 on the touchscreen GUI display screen 26 including a user selectable golf hole images 42 associated with the identified eligible golf hole locations. The processor 18, 22 then receives a user selection of an eligible golf hole location via the golf hole selection screen 32 and generates a golf skill shot datafile 44 (shown in FIG. 8) including information identifying the user selected eligible golf hole location (e.g. golf hole ID).

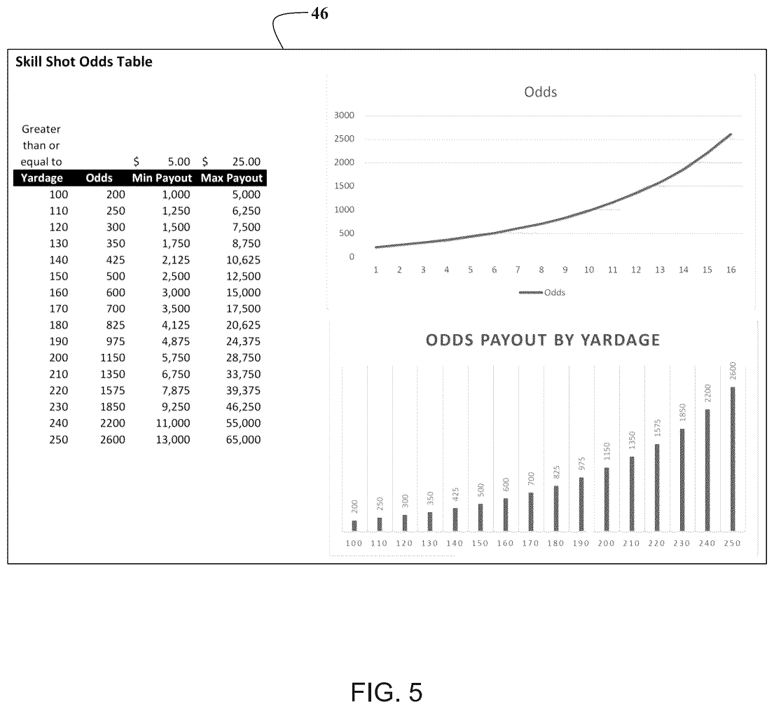

In method step 204, the processor 18, 22 accesses a wagering odds data file 46 (shown in FIG. 5) stored in the database 20 and retrieves wagering data including wagering events associated with the player selected hole location, displays the associated wagering events on the mobile computing device 14, and receives a player selection of one or more wagering events associated with the player selected hole location via the mobile computing devices 14. For example, in some embodiments, the processor 18, 22 may render the golf hole selection screen 32 including a token selection user interface element 48 (shown in FIG. 17) for entering a number of token associated with successful completion of the golf skill shot. The processor 18, 22 then receives a user selected amount of tokens from the token selection user interface clement 48 and deducts the user selected amount of tokens from a user account 38 associated with the mobile computing device 14.

In method step 206, the processor 18, 22 receives a unique golf ball identifier associated with a golf ball being used during the golf skill shot competition. For example, the processor 18, 22 may prompt the player to capture and send a photograph and/or video image of the golf ball including a unique golf ball identifier embossed and/or displayed on the golf ball. Upon receiving the unique golf ball identifier, the processor 18, 22 creates a unique skill shot record including the unique golf ball identifier, received GPS data, the player selected wagering event and hole location. In some embodiments, in addition to the golf ball manufacturer and ball number, the processor 18, 22 will generate a random two-digit alphanumeric code to be written onto the golf ball by the user and then shown to the camera before teeing off.

In method step 208, the processor 18, 22 receives video images of the player performing the golf skill shot competition via the mobile computing device 14. For example, the processor 18, 22 may prompt the player to record a video of the player attempting a hole-in-one at the selected hole location.

In method step 210, the processor 18, 22 verifies the completion of the golf skill shot competition based on the received video images of the player performing the golf skill shot competition, determines the outcome of the golf skill shot competition, and provides an award to the player based on the determined outcome of the golf skill shot competition and the player selected player selected wagering event.

For example, in the illustrated embodiment, the processor 18, 22 is programmed to execute the computer-executable instructions to perform the algorithm to capture video images of a player completing a golf skill shot including the steps of receiving a request to record video images of the golf skill shot via the touchscreen GUI display screen 26 and initiating a golf skill shot capture event by receiving geolocation information of the mobile computing device 14 via the GPS device identifying a position of the mobile computing device 14, accessing the golf course datafile 40 and identifying eligible golf hole locations based on the received geolocation information of the mobile computing device 14, and rendering the golf hole selection screen 32 on the touchscreen GUI display screen 26 including a user selectable golf hole images 42 associated with the identified eligible golf hole locations. The processor 18, 22 then receives a user selection of an eligible golf hole location via the golf hole selection screen 32 and then renders the golf hole selection screen 32 including a token selection user interface element 48 for entering a number of tokens associated with successful completion of the golf skill shot. The processor 18, 22 then receives a user selected amount of tokens from the token selection user interface element 48, and displays a video capture screen 50 on the touchscreen GUI display screen 26 including a video capture window 52 displaying images received from the video camera 28 and a video record button 54.

The processor 18, 22 then receives a first user selection via the touchscreen GUI display screen 26 of the video record button 54 to initiate a video recording session by the player and initiates the video recording session by
receiving initial geolocation information of the mobile computing device via the GPS device identifying a position of the mobile computing device 14 when the video recording session is initiated and begins recording video images shown in the video capture window 52 being capture by the video camera 28 including the player performing the golf skill shot.

The processor 18, 22 then randomly selects a two-digit code 56 and renders a golf skill shot confirmation window 58 on the video capture screen 50 overlaying a portion of the video capture window 52 including the randomly selected two-digit code 56 and a confirmation button 60.

The randomly selected two-digit code 56 may be a numeric code, an alpha-numeric code, an alphabet code, and/or any suitable code of symbols that is recognizable by image analyzer software. The golf skill shot confirmation window 58 also include a prompt informing the player to hand-write the displayed two-digit code 56 on the golf ball.

The processor 18, 22 then receives a second user selection via touchscreen GUI display screen 26 of the confirmation button 60, removes the golf skill shot confirmation window 58 from the video capture screen and while continuing to record video images shown in the video capture window 52, and generates the golf skill shot datafile 44 including the randomly selected two-digit code 56, the received initial geolocation information from the GPS device, and the user selected amount of tokens from the token selection user interface element 48.

The processor 18, 22 may also deduct the user selected amount of tokens from a user account 38 associated with the mobile computing device 14 upon initiating the video recording session and/or receives the user selection of the confirmation button 60.

The processor 18, 22 continues record video images of the player completing the golf skill event including, for example, completing a hole-in-one on an eligible golf hole, and upon completing the golf skill event, the player may stop the video recording to confirm completion of the golf skill event. For example, processor 18, 22 continues recording video images of the player completing the golf skill event until receiving a third user selection via touchscreen GUI display screen 26 of the video record button 54 to stop the video recording. Upon receiving the player's selection of the video record button 54, the processor 18, 22 then terminates the video recording session by stopping the recording of video images shown in the video capture window 52 and modifying the golf skill shot datafile 44 to include video capture data 62 including the recorded video images shown in the video capture window 52.

In some embodiments, the processor 18, 22 receives final geolocation information of the mobile computing device via the GPS device identifying a final position of the mobile computing device 14 when the video recording session is terminated, and modifies the golf skill shot datafile 44 to include the final geolocation information.

The processor 18, 22 then analyzes the video capture data 62 to detect video images of a golf ball and completion of the golf skill shot by the player, and renders a celebration notification screen 64 (shown in FIG. 24) on the touchscreen GUI display screen 26 upon determining the recorded video images of the golf ball displays a hand-written two-digit code matching the randomly selected two-digit code 56 displayed on the golf skill shot confirmation window 58 and the recorded video images show successful completion of the golf skill shot.

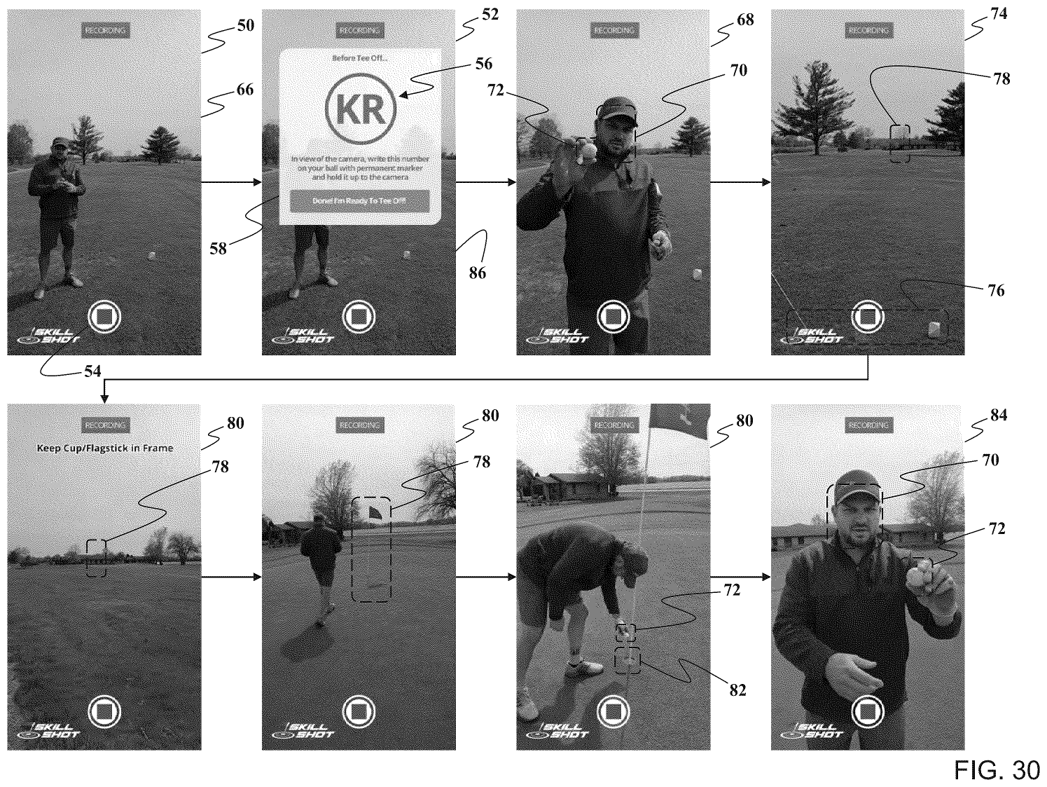

For example, as shown in FIG. 30, in some embodiments the processor 18, 22 may use the image analyzer software 30 to review the video frames 66 include in the video capture data 62. The processor 18, 22 then uses the image analyzer software 30 to analyzing the video frames 66 of the video capture data 62 to determine successful completion of the golf skill shot, including detecting a first set of video frames 68 including images of a players face 70 and the golf ball 72 displaying the hand-written two-digit code before the player initiates the golf skill shot, detecting a second set of video frames 74 including images of the player initiating the golf skill shot from a tee box 76 with images of a golf hole green 78 in a background, detecting a third set of video frames 80 including images of a travel of the golf ball to a golf hole cup 82 on the golf hole green 78, and detecting a fourth set of video frames 84 including images of the players face 70 and the golf ball 72 displaying the hand-written two-digit code as the golf ball is retrieved from the golf hole cup 82.

In some embodiments, the processor 18, 22 may also detect a fifth set of video frames 86 included in the video capture data 62 including screenshot images of the golf skill shot confirmation window 58 including the randomly selected two-digit code 56 in order to determine a successful completion of the golf skill shot.

In addition, the processor 18, 22 may determine successful completion of the golf skill shot including accessing the golf course datafile 40 including geolocation information associated with eligible golf hole locations and determine the successful completion of the golf skill shot upon verifying the received initial geolocation information included in the golf skill shot datafile 44 matches corresponding geolocation information associated with the player selected eligible golf hole. The processor 18, 22 may also determine successful completion of the golf skill shot upon verifying the final geolocation information included in the golf skill shot datafile 44 matches the corresponding geolocation information associated with the player selected eligible golf hole included in the golf skill shot datafile 44.

Upon verifying the completion of the golf skill shot competition based on the received video images of the player performing the golf skill shot competition, the processor 18, 22 may then access the wagering odds data file 46, retrieve the wagering data associated with the player selected hole location, determine an amount of awards tokens awarded to the player based on t the wagering data associated with the player selected hole location and the user selected amount of tokens received from the token selection user interface element 48, and display the celebration notification screen 64 including an award image 88 displaying the determined amount of tokens awarded to the player. The processor 18, 22 then updates the corresponding user account 38 to includes the amount of tokens included in the user account to include the determined amount of tokens awarded to the player.

In some embodiments, the processor 18, 22 performs a Verification Workflow for Instances of a Claimed Hole-in-One including:
1. The user sets up account with a form of valid government issued photo i.d., with age verification of over 18 years old (along with payment info, phone and email.) Stored in AWS
   a. A third party ID verification vendor named Plaid™ to authenticate users age and validity. All ID information will be securely stored within Plaids™ database and called upon by Skill Shot™ as needed. A third party payment processor called Authorize.net™ is used for all payment info. All of this information will be securely stored in their database.
2. Initial Course selection is determined to be in a qualifying State.
3. Hole-in-One is submitted. (Assumed that a GPS pin is dropped at the start of the video and when the video is turned off)
4. A notification goes out to the user.
   a. Email & Push notification.
      i. User we will be reviewing your claim, profile and your video evidence of your HOI, you will receive an update on the status of your claim with the next steps within 4 business days.
5. Email/Admin alert of a HOI claim in the hopper.
   a. Skill Shot will watch the video to check the requirements are met.
      i. The user and the ball i.d. (John Smith with a Callaway 2) are verified at the start of the video.
      ii. The user and hole are in frame for the shot.
      iii. The hole is in frame with clear view of the ball going into the cup.
      iv. The camera reverts back to original zoom and the hole is kept in frame of the shot and the video has continuous footage to the green through the retrieval of the ball.
      v. The ball is filmed in the hole, and the user retrieves the ball and shows the camera the ball i.d. (e.g. Callaway 2 and randomly generated two digit code, e.g. “X5”)
      vi. The GPS pins are used to verify the hole location on the course and verify the correct tee box was used with distances (may be off by X amount of yards)
      vii. If the video is inconclusive, we will follow up with witness affidavits.
6. If the HOI is determined to have insufficient supporting evidence/disqualifying circumstances i.e. picked black tees and shot from red. An email with an explanation, an email & push notification is sent to the user explaining why the HOI was not qualifying.
7. If the HOI is deemed Valid we will go through the next steps.
   a. Email is submitted to the user that we have determined the HOI to a winner, and that we will need some further information to be able to submit the funds.
      i. Collect Social Security Number for Tax purposes
      ii. Ask the user how they prefer to receive funds and the information that is needed to send the funds i.e. check, ACH, Paypal, Venmo.
      iii. Inquire if they would send a photo if we sent a Big Check
      iv. Do you want us to submit your claim to the national HIO registry?

While exemplary systems and methods, and applications of methods of the invention, have been described herein, it should also be understood that the foregoing and the attached materials, which describe a non-limiting exemplary embodiment of the invention, are only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth herein and in the attached materials, including any equivalents thereto.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A computer system for use in capturing video images of sport skill event, comprising:
a mobile computing device including:
a touchscreen display device including a graphical user interface (GUI) display screen displaying computer-generated images thereon;
a video camera for capturing video images;
a memory device including computer-executable instructions for performing an algorithm to capture video images of a player completing a golf skill shot; and
one or more processors programmed to execute the computer-executable instructions to perform the algorithm, including the steps of:
receiving a request to record video images of the golf skill shot via the touchscreen GUI display screen and initiating a golf skill shot capture event by:
displaying a video capture screen on the touchscreen GUI display screen including a video capture window displaying images received from the video camera and a video record button;
receiving a first user selection via the touchscreen GUI display screen of the video record button to initiate a video recording session and initiating the video recording session by:
recording video images shown in the video capture window being capture by the video camera including the player performing the golf skill shot;
rendering a golf skill shot confirmation window on the video capture screen overlaying a portion of the video capture window including a confirmation button; and
receiving a second user selection via touchscreen GUI display screen of the confirmation button and removing the golf skill shot confirmation window from the video capture screen;
receiving a third user selection via touchscreen GUI display screen of the video record button and terminating the video recording session by:
stopping the recording of video images shown in the video capture window; and
generating a golf skill shot datafile including video capture data including the recorded video images shown in the video capture window;
analyzing the video capture data to detect video images of a golf ball and completion of the golf skill shot by the player; and
rendering a celebration notification screen on the touchscreen GUI display screen upon determining the recorded video images show successful completion of the golf skill shot.

2. The computer system of claim 1, wherein the one or more processors is programmed to execute the algorithm including the steps of:
rendering the golf skill shot confirmation window including a randomly selected two-digit code;
generating the golf skill shot datafile including the randomly selected two-digit code and the video capture data including the recorded video images shown in the video capture window; and
rendering the celebration notification screen upon determining the recorded video images of the golf ball displays a hand-written two-digit code matching the randomly selected two-digit code displayed on the golf skill shot confirmation window.

3. The computer system of claim 2, wherein the one or more processors is programmed to execute the algorithm including the steps of:
analyzing video frames of the video capture data to determine successful completion of the golf skill shot, including:
detecting a first set of video frames including images of a players face and the golf ball displaying the hand-written two-digit code before the player initiates the golf skill shot;
detecting a second set of video frames including images of the player initiating the golf skill shot from a tee box with images of a golf hole green in a background;
detecting a third set of video frames including images of a travel of the golf ball to a golf hole cup on the golf hole green; and
detecting a fourth set of video frames including images of the players face and the golf ball displaying the hand-written two-digit code as the golf ball is retrieved from the golf hole cup.

4. The computer system of claim 3, wherein the one or more processors is programmed to execute the algorithm including the steps of:
detecting a fifth set of video frames including images of the golf skill shot confirmation window including the randomly selected two-digit code.

5. The computer system of claim 1, wherein the mobile computing device includes a global positioning system (GPS) device, the one or more processors is programmed to execute the algorithm including the steps of:
receiving initial geolocation information of the mobile computing device via the GPS device identifying a position of the mobile computing device when the video recording session is initiated; and
generating the golf skill shot datafile including the received initial geolocation information.

6. The computer system of claim 5, wherein the one or more processors is programmed to execute the algorithm including the steps of:
accessing a golf course datafile including geolocation information associated with eligible golf hole locations; and
determining successful completion of the golf skill shot upon verifying the received initial geolocation information included in the golf skill shot datafile matches corresponding geolocation information associated with an eligible golf hole.

7. The computer system of claim 5, wherein the one or more processors is programmed to execute the algorithm including the steps of:
initiating the golf skill shot capture event by:
accessing the golf course datafile and identifying eligible golf hole locations based on the received geolocation information of the mobile computing device;
rendering a golf hole selection screen on the touchscreen GUI display screen including a user selectable golf hole images associated with the identified eligible golf hole locations;
receiving a user selection of an eligible golf hole location via the hole selection screen; and
generating the golf skill shot datafile including information identifying the user selected eligible golf hole location.

8. The computer system of claim 7, wherein the one or more processors is programmed to execute the algorithm including the steps of:
rendering the golf hole selection screen including a token selection user interface element for entering a number of token associated with successful completion of the golf skill shot;
receiving a user selected amount of tokens from the token selection user interface element;
deducting the user selected amount of tokens from a user account associated with the mobile computing device upon initiating the video recording session; and
displaying the celebration notification window including an award image displaying an amount of tokens awarded based on the user selected amount of tokens received from the token selection input image.

9. A method of operating a computer system including a mobile computing device including a touchscreen display device including a graphical user interface (GUI) display screen displaying computer-generated images thereon, a video camera for capturing video images, a memory device including computer-executable instructions for performing an algorithm to capture video images of a player completing a golf skill shot, and one or more processors programmed to execute the computer-executable instructions to perform the algorithm, the method including the one or more processors performing the algorithm including the steps of:
receiving a request to record video images of the golf skill shot via the touchscreen GUI display screen and initiating a golf skill shot capture event by:
displaying a video capture screen on the touchscreen GUI display screen including a video capture window displaying images received from the video camera and a video record button;
receiving a first user selection via the touchscreen GUI display screen of the video record button to initiate a video recording session and initiating the video recording session by:
recording video images shown in the video capture window being capture by the video camera including the player performing the golf skill shot;
rendering a golf skill shot confirmation window on the video capture screen overlaying a portion of the video capture window including a confirmation button; and
receiving a second user selection via touchscreen GUI display screen of the confirmation button and removing the golf skill shot confirmation window from the video capture screen;
receiving a third user selection via touchscreen GUI display screen of the video record button and terminating the video recording session by:
stopping the recording of video images shown in the video capture window; and
generating a golf skill shot datafile including video capture data including the recorded video images shown in the video capture window;
analyzing the video capture data to detect video images of a golf ball and completion of the golf skill shot by the player; and
rendering a celebration notification screen on the touchscreen GUI display screen upon determining the recorded video images show successful completion of the golf skill shot.

10. The method of claim 9, including the one or more processors performing the algorithm including the steps of:
rendering the golf skill shot confirmation window including a randomly selected two-digit code;
generating the golf skill shot datafile including the randomly selected two-digit code and the video capture data including the recorded video images shown in the video capture window; and
rendering the celebration notification screen upon determining the recorded video images of the golf ball displays a hand-written two-digit code matching the randomly selected two-digit code displayed on the golf skill shot confirmation window.

11. The method of claim 10, including the one or more processors performing the algorithm including the steps of:
analyzing video frames of the video capture data to determine successful completion of the golf skill shot, including:
detecting a first set of video frames including images of a players face and the golf ball displaying the hand-written two-digit code before the player initiates the golf skill shot;
detecting a second set of video frames including images of the player initiating the golf skill shot from a tee box with images of a golf hole green in a background;
detecting a third set of video frames including images of a travel of the golf ball to a golf hole cup on the golf hole green; and
detecting a fourth set of video frames including images of the players face and the golf ball displaying the hand-written two-digit code as the golf ball is retrieved from the golf hole cup.

12. The method of claim 11, including the one or more processors performing the algorithm including the steps of:
detecting a fifth set of video frames including images of the golf skill shot confirmation window including the randomly selected two-digit code.

13. The method of claim 9, including the one or more processors performing the algorithm including the steps of:
receiving initial geolocation information of the mobile computing device via the GPS device identifying a position of the mobile computing device when the video recording session is initiated; and
generating the golf skill shot datafile including the received initial geolocation information.

14. The method of claim 13, including the one or more processors performing the algorithm including the steps of:
accessing a golf course datafile including geolocation information associated with eligible golf hole locations; and
determining successful completion of the golf skill shot upon verifying the received initial geolocation information included in the golf skill shot datafile matches corresponding geolocation information associated with an eligible golf hole.

15. The method of claim 13, including the one or more processors performing the algorithm including the steps of:
initiating the golf skill shot capture event by:
accessing the golf course datafile and identifying eligible golf hole locations based on the received geolocation information of the mobile computing device;
rendering a golf hole selection screen on the touchscreen GUI display screen including a user selectable golf hole images associated with the identified eligible golf hole locations;
receiving a user selection of an eligible golf hole location via the hole selection screen; and
generating the golf skill shot datafile including information identifying the user selected eligible golf hole location.

16. The method of claim 15, including the one or more processors performing the algorithm including the steps of:
rendering the golf hole selection screen including a token selection user interface element for entering a number of token associated with successful completion of the golf skill shot;
receiving a user selected amount of tokens from the token selection user interface element;
deducting the user selected amount of tokens from a user account associated with the mobile computing device upon initiating the video recording session; and
displaying the celebration notification window including an award image displaying an amount of tokens awarded based on the user selected amount of tokens received from the token selection input image.

17. A non-transitory computer-readable storage media having computer-executable instructions embodied thereon for operating a computer system including a mobile computing device including a touchscreen display device including a graphical user interface (GUI) display screen displaying computer-generated images thereon, a video camera for capturing video images, and one or more processors, when executed by the one or more processors the computer-executable instructions cause the one or more processors to perform an algorithm to capture video images of a player completing a golf skill shot including the steps of:
receiving a request to record video images of the golf skill shot via the touchscreen GUI display screen and initiating a golf skill shot capture event by:
displaying a video capture screen on the touchscreen GUI display screen including a video capture window displaying images received from the video camera and a video record button;
receiving a first user selection via the touchscreen GUI display screen of the video record button to initiate a video recording session and initiating the video recording session by:
recording video images shown in the video capture window being capture by the video camera including the player performing the golf skill shot;
rendering a golf skill shot confirmation window on the video capture screen overlaying a portion of the video capture window including a confirmation button; and
receiving a second user selection via touchscreen GUI display screen of the confirmation button and removing the golf skill shot confirmation window from the video capture screen;
receiving a third user selection via touchscreen GUI display screen of the video record button and terminating the video recording session by:
stopping the recording of video images shown in the video capture window; and
generating a golf skill shot datafile including video capture data including the recorded video images shown in the video capture window;
analyzing the video capture data to detect video images of a golf ball and completion of the golf skill shot by the player; and
rendering a celebration notification screen on the touchscreen GUI display screen upon determining the recorded video images show successful completion of the golf skill shot.

18. The non-transitory computer-readable storage media of claim 17, wherein the computer-executable instructions cause the one or more processors to execute the algorithm including the steps of:
rendering the golf skill shot confirmation window including a randomly selected two-digit code;
generating the golf skill shot datafile including the randomly selected two-digit code and the video capture data including the recorded video images shown in the video capture window; and
rendering the celebration notification screen upon determining the recorded video images of the golf ball displays a hand-written two-digit code matching the randomly selected two-digit code displayed on the golf skill shot confirmation window.

19. The non-transitory computer-readable storage media of claim 18, wherein the computer-executable instructions cause the one or more processors to execute the algorithm including the steps of:
analyzing video frames of the video capture data to determine successful completion of the golf skill shot, including:
detecting a first set of video frames including images of a players face and the golf ball displaying the hand-written two-digit code before the player initiates the golf skill shot;
detecting a second set of video frames including images of the player initiating the golf skill shot from a tee box with images of a golf hole green in a background;
detecting a third set of video frames including images of a travel of the golf ball to a golf hole cup on the golf hole green; and
detecting a fourth set of video frames including images of the players face and the golf ball displaying the hand-written two-digit code as the golf ball is retrieved from the golf hole cup; and
detecting a fifth set of video frames including images of the golf skill shot confirmation window including the randomly selected two-digit code.

20. The non-transitory computer-readable storage media of claim 18, wherein the computer-executable instructions cause the one or more processors to execute the algorithm including the steps of:
receiving initial geolocation information of the mobile computing device via the GPS device identifying a position of the mobile computing device when the video recording session is initiated;
generating the golf skill shot datafile including the received initial geolocation information;
accessing a golf course datafile including geolocation information associated with eligible golf hole locations; and
determining successful completion of the golf skill shot upon verifying the received initial geolocation information included in the golf skill shot datafile matches corresponding geolocation information associated with an eligible golf hole.
